(19) United States
(12) Patent Application Publication
(10) Pub. No.: US 2026/0170793 A1
(43) Pub. Date: Jun. 18, 2026

(54) INFORMATION PROCESSING DEVICE

(71) Applicant: TOYOTA JIDOSHA KABUSHIKI KAISHA, Toyota-shi (JP)

(72) Inventors: Satoshi MIYAKE, Toyota-shi (JP); Mitsuhiro Mabuchi, Edogawa-ku (JP)

(73) Assignee: TOYOTA JIDOSHA KABUSHIKI KAISHA, Toyota-shi (JP)

(21) Appl. No.: 19/351,804

(22) Filed: Oct. 7, 2025

(30) Foreign Application Priority Data
Dec. 16, 2024 (JP) 2024-220196

(51) Int. Cl. G06V 10/46; G06V 10/26; G06V 10/94

(52) U.S. Cl. CPC G06V 10/462; G06V 10/26; G06V 10/945

(57) ABSTRACT

An information processing device includes an analyzer that subjects image data to saliency analysis processing, and a generator that generates a graph structure relating to a region of an image related to the image data, in which region a saliency is higher than a predetermined threshold value, based on a result of the saliency analysis processing.

### CROSS-REFERENCE TO RELATED APPLICATION

This application claims priority to Japanese Patent Application No. 2024-220196 filed on Dec. 16, 2024. The disclosure of the above-identified application, including the specification, drawings, and claims, is incorporated by reference herein in its entirety.

### BACKGROUND

### 1. Technical Field

The present disclosure relates to the technical field of information processing devices.

### 2. Description of Related Art

As one example of this type of device, a system has been proposed in which a large language model (LLM) is used to generate query data based on documents, and pairs of the documents and the query data are used to train a search model for a conversational bot (see Japanese Unexamined Patent Application Publication No. 2023-076413 (JP 2023-076413 A)).

### SUMMARY

The term “large language model” refers to a language model constructed using extremely large datasets and deep learning technology. For example, the dataset may include image data. Now, as a method for extracting characteristics of image data, a method has been proposed in which a graph structure is generated based on image data, and characteristics of the image data are extracted based on this graph structure that is generated. When a graph structure is generated simply based on image data, for example, unnecessary information may be reflected in the graph structure. In this case, the graph structure may become unnecessarily large. Furthermore, when the graph structure is used for model training (in other words, for training artificial intelligence (AI)), this may affect training and precision of inference.

The present disclosure has been made in view of the above circumstances, and an object thereof is to provide an information processing device that can suppress a graph structure from becoming unnecessarily large.

An information processing device according to one aspect of the present disclosure includes an analyzer that subjects image data to saliency analysis processing, and a generator that generates a graph structure relating to a region of an image related to the image data, in which region a saliency is higher than a predetermined threshold value, based on a result of the saliency analysis processing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of an information processing device according to an embodiment;

FIG. 2 is a block diagram illustrating an example of a configuration of a computing device according to the embodiment;

FIG. 3 is a conceptual diagram illustrating an example of operations of the information processing device according to the embodiment; and

FIG. 4 is a diagram illustrating an example of a display screen.

### DETAILED DESCRIPTION OF EMBODIMENTS

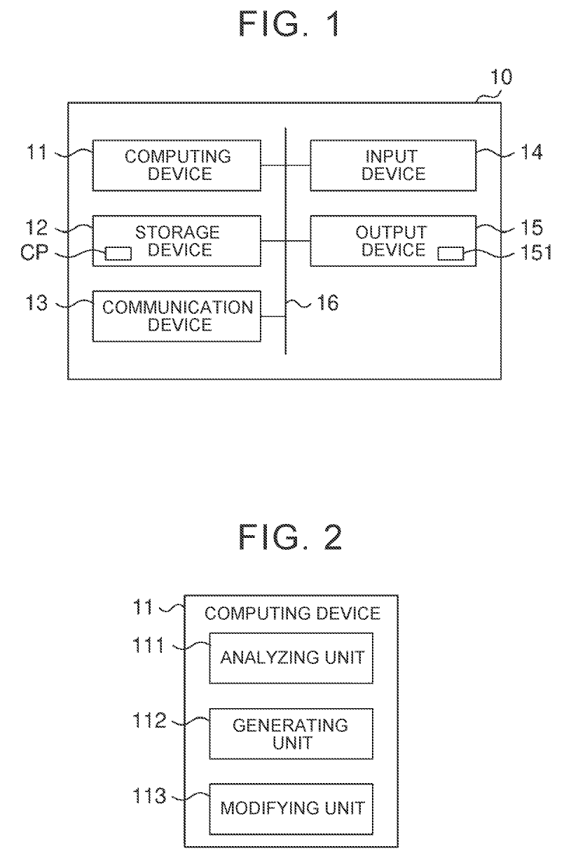

An embodiment of an information processing device will be described with reference to FIGS. 1-4. In FIG. 1, an information processing device 10 includes a computing device 11, a storage device 12, a communication device 13, an input device 14, and an output device 15. The computing device 11, the storage device 12, the communication device 13, the input device 14, and the output device 15 are connected via a data bus 16.

The computing device 11 may include a processor. Note that the computing device 11 may include a single processor or a plurality of processors. In other words, the computing device 11 may include one or more processors. Note that the processor may be a multi-core processor. When the computing device 11 includes a single processor that is a multi-core processor, the computing device 11 may be regarded as logically including a plurality of processors.

The processor may be, for example, at least one of a central processing unit (CPU), a graphics processing unit (GPU), a field programmable gate array (FPGA), and a tensor processing unit (TPU).

The storage device 12 may be, for example, at least one of random access memory (RAM), read-only memory (ROM), a hard disk drive, a magneto-optical disk drive, a solid state drive (SSD), and an optical disk array. That is to say, the storage device 12 may be realized using a single device or a plurality of devices.

The communication device 13 may be capable of communicating with a device that is external to the information processing device 10. Note that the communication device 13 may perform wired communication or wireless communication.

The input device 14 is a device capable of externally receiving input of information to the information processing device 10. The input device 14 may include an operation device operable by a user of the information processing device 10 (e.g., keyboard, mouse, touch panel, or the like). The input device 14 may include a recording medium reader capable of reading information recorded in a recording medium such as, for example, Universal Serial Bus (USB) memory or the like, that is attachable to and detachable from the information processing device 10. Note that when information is input to the information processing device 10 via the communication device 13 (i.e., when the information processing device 10 acquires information via the communication device 13), the communication device 13 may function as an input device.

The output device 15 is a device that is capable of externally outputting information from the information processing device 10. The output device 15 has a display device 151 that can output visual information, such as text, images, and so forth, as the above information. Note that the output device 15 may include a speaker that is capable of outputting auditory information, such as sound or the like, as the information. The output device 15 may include a vibration motor that is capable of outputting tactile information, such as vibrations or the like, as the information. The output device 15 may include a printer. The output device 15 may be capable of outputting information to a recording medium, such as, for example, USB memory or that like, that is attachable to and detachable from the information processing device 10. Note that the information processing device 10 outputs information via the communication device 13, the communication device 13 may function as an output device.

The storage device 12 is capable of storing desired data. The storage device 12 may store a computer program CP that is executed by the computing device 11. When the computing device 11 is executing the computer program CP, the storage device 12 may temporarily store data temporarily used by the computing device 11.

Note that the computer program CP may be recorded on a computer-readable non-transitory recording medium. In this case, the computer program CP may be stored in the storage device 12 by reading the recording medium using a recording medium reader, omitted from illustration, which is included in the information processing device 10. Note that at least one of an optical disk, a magnetic medium, a magneto-optical disk, semiconductor memory, and any other medium capable of storing programs, may be used as the recording medium. Note that the computer program CP may be acquired from a device, omitted from illustration, that is external to the information processing device 10 via the communication device 13. In other words, the computer program CP may be downloaded from an external device to the storage device 12 of the information processing device 10.

The computing device 11 (e.g., a processor), together with the storage device 12 storing the computer program CP (in other words, together with the storage device 12 and the computer program CP stored in the storage device 12), may execute processing that is to be performed by the information processing device 10. For example, logical functional blocks for executing the processing to be performed by the information processing device 10 may be realized within the computing device 11 (e.g., within the processor) by the computing device 11 executing the computer program CP.

As illustrated in FIG. 2, the computing device 11 includes an analyzing unit 111 , a generating unit 112 , and a modifying unit 113 . The analyzing unit 111, the generating unit 112, and the modifying unit 113 may be realized as the aforementioned logical functional blocks. Note that at least one of the analyzing unit 111, the generating unit 112, and the modifying unit 113 may be realized as a physical processing circuit. At least one of the analyzing unit 111, the generating unit 112, and the modifying unit 113 may be realized in a form in which logical functional blocks and physical processing circuits coexist.

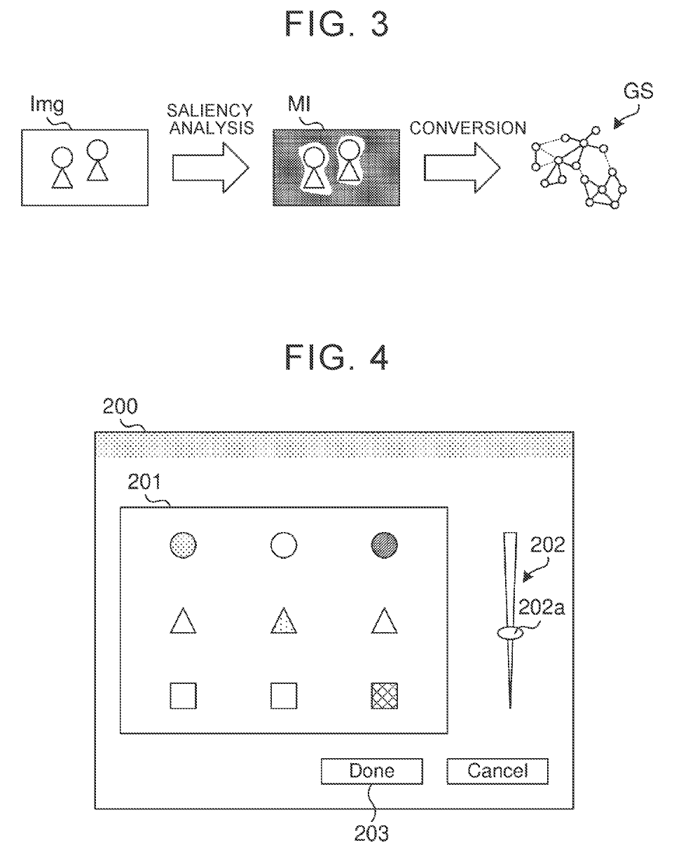

Operations of the information processing device 10 will be described with reference to FIG. 3. For example, the analyzing unit 111 of the information processing device 10 performs saliency analysis processing on image data relating to an image Img illustrated in FIG. 3. Note that various existing forms can be applied to the saliency analysis processing. Accordingly, detailed description of the saliency analysis processing will be omitted. It should be noted that the image data may be image data included in an image dataset used to train the model.

The generating unit 112 of the information processing device 10 may generate a masked image MI in which regions with saliency lower than a predetermined threshold value are masked based on results of the saliency analysis processing. That is to say, in the masked image MI, regions of which the saliency is higher than the predetermined threshold value are not masked. Note that when the saliency of a region is "equal" to the predetermined threshold value, this region may be treated as either one. Note that the masked image MI may also be referred to as a saliency map.

The generating unit 112 generates a graph structure (e.g., graph structure GS) based on the masked image MI. That is to say, the generating unit 112 generates a graph structure relating to the unmasked regions in the masked image MI (in other words, regions of which saliency is higher than a predetermined threshold value). Note that the graph structure may refer to data that is made up of a group of nodes that represent relationships between parts of an object in an image related to one piece of image data, and a group of edges that represent the relations between the nodes. It should be noted that various existing forms can be applied as a method to generate the graph structure. Accordingly, detailed description of the method for generating the graph structure will be omitted.

For example, after the saliency analysis processing is performed on the image data, but before the masked image MI is generated, the computing device 11 may control the display device 151 to display an image 200 illustrated in FIG. 4. The image 200 includes a region 201 for displaying a preview image and a slider 202. The user of the information processing device 10 may manipulate a knob 202a of the slider 202 via the input device 14 to change the predetermined threshold value. Specifically, the modifying unit 113 of the information processing device 10 may change the predetermined threshold value in accordance with the position of the knob 202a on the slider 202. Changing the threshold value changes the region to be masked in the masked image (e.g., masked image MI). The computing device 11 may control the display device 151 to display a preview of a masked image that is generated when the predetermined threshold value is changed. When the user selects a button 203 included in the image 200 via the input device 14, the generating unit 112 may generate a masked image in which regions of which the saliency is lower than the threshold value changed by the user are masked.

### Technical Effects

In the present embodiment, the analyzing unit 111 performs saliency analysis processing on the image data. Then, based on the results of the saliency analysis processing, the generating unit 112 generates a graph structure relating to, out of images relating to the image data, regions of which the saliency is higher than the predetermined threshold value. That is to say, information regarding regions of which the saliency is lower than the predetermined threshold value is not included in the graph structure that is generated. Here, when image data is used for training of a model, a region with saliency that is higher than the predetermined threshold value can be said to be a region that is relatively highly relevant to learning. In other words, a region with saliency that is lower than the predetermined threshold value can be said to be a region that is relatively low in relevancy regarding learning. Accordingly, information regarding regions of which the saliency is lower than the predetermined threshold value can be said to be information that is unnecessary for training of the model. As described above, the generating unit 112 generates a graph structure regarding regions of which the saliency is higher than the predetermined threshold value. Accordingly, the information processing device 10 according to the present embodiment can suppress unnecessary information from being reflected in the graph structure. As a result, the information processing device 10 can suppress the graph structure from becoming unnecessarily large.

Aspects of the disclosure that are derived from the above-described embodiment will be described below.

An information processing device according to one aspect of the disclosure includes an analyzer that subjects image data to saliency analysis processing, and a generator that generates a graph structure relating to, out of regions included in an image related to the image data, a region in which a saliency is higher than a predetermined threshold value, based on a result of the saliency analysis processing. In the above-described embodiment, the "analyzing unit 111" corresponds to an example of the "analyzer", and the "generating unit 112" corresponds to an example of the "generator".

In the information processing device relating to the above aspect, the generator may generate a masked image in which, out of regions included in the image, a region of which the saliency is lower than the predetermined threshold value is masked, and generate the graph structure based on the masked image. According to this configuration, a graph structure regarding regions in which saliency is higher than a predetermined threshold value can be generated relatively easily.

The information processing device according to the above aspect may further include an accepter that accepts user input, and a modifier that modifies the predetermined threshold value in response to the user input accepted by the accepter. This configuration enables the user to adjust the threshold value relatively easily, which is advantageous in practice. In the above-described embodiment, the "input device 14" corresponds to an example of the "accepter", and the "modifying unit 113" corresponds to an example of the "modifier".

The present disclosure is not limited to the above-described embodiment, and can be modified as appropriate without departing from the gist or spirit of the disclosure as can be read from the claims and the entire specification, and information processing devices involving such modifications are also included in the technical scope of the present disclosure.

What is claimed is:

1. An information processing device comprising:
an analyzer that subjects image data to saliency analysis processing; and
a generator that generates a graph structure relating to a region of an image related to the image data, in which region a saliency is higher than a predetermined threshold value, based on a result of the saliency analysis processing.

2. The information processing device according to claim 1, wherein
the generator
generates a masked image, in which a region of the image of which the saliency is lower than the predetermined threshold value, is masked, and
generates the graph structure based on the masked image.

3. The information processing device according to claim 1, further comprising:
an accepter that accepts user input; and
a modifier that modifies the predetermined threshold value in response to the user input accepted by the accepter.
